(19) United States
(12) Patent Application Publication
(10) Pub. No.: US 2026/0091664 A1
(43) Pub. Date: Apr. 2, 2026

(54) THERMAL MANAGEMENT SYSTEM FOR VEHICLE

(71) Applicant: CNH INDUSTRIAL AMERICA LLC, New Holland, PA (US)

(72) Inventors: Sudarshan Sirigere, Naperville, IL (US); Pankaj Vazirani, Ann Arbor, MI (US); Sai Malavika Venkatesh, Novi, MI (US)

(73) Assignee: CNH INDUSTRIAL AMERICA LLC, New Holland, PA (US)

(21) Appl. No.: 18/899,102

(22) Filed: Sep. 27, 2024

(51) Int. Cl. B60K 11/04; B60L 15/00; B60L 50/60; H01M 10/613; H01M 10/625; H01M 10/633; H01M 10/6551; H01M 10/6569; H01M 10/66; H01M 50/249

(52) U.S. Cl. CPC B60K 11/04; B60L 15/007; B60L 50/60; H01M 10/613; H01M 10/625; H01M 10/633; H01M 10/6551; H01M 10/6569; H01M 10/66; H01M 50/249; B60L 2200/40; H01M 2220/20

(57) ABSTRACT

A thermal management system for a vehicle includes a pump configured to circulate a coolant through the thermal management system, a first position in fluid communication with the pump, a heat exchanger portion in thermal communication with a fluid distribution system of the vehicle, and a first valve transitionable between a first configuration and a second configuration. The first portion is in thermal communication with a component of a drivetrain of a vehicle. The first portion is in fluid communication with the heat exchanger portion when the first valve is in the first configuration. The first valve blocks fluid communication between the first portion and the heat exchanger portion when the first valve is in the second configuration.

### BACKGROUND

The present disclosure relates generally to a vehicle (e.g., a tractor, a truck, etc.). More specifically, the present disclosure relates to an electric vehicle with a thermal management system. The thermal management system facilitates the operation of the vehicle by transferring heat between systems (e.g., an electric system, a hydraulic system, etc.) of the vehicle.

### SUMMARY

One embodiment relates to a thermal management system for a vehicle. The thermal management system includes a pump configured to circulate a coolant through the thermal management system, a first position in fluid communication with the pump, a heat exchanger portion in thermal communication with a fluid distribution system of the vehicle, and a first valve transitionable between a first configuration and a second configuration. The first portion is in thermal communication with a component of a drivetrain of a vehicle. The first portion is in fluid communication with the heat exchanger portion when the first valve is in the first configuration. The first valve blocks fluid communication between the first portion and the heat exchanger portion when the first valve is in the second configuration.

Another embodiment relates to a vehicle. The vehicle includes a chassis, a drivetrain coupled to the chassis, a fluid distribution system configured to circulate fluid to at least one subsystem of the vehicle, and a thermal management system configured to circulate coolant. The drivetrain includes a battery system and an electric motor configured to consume electrical energy provided by the battery system to propel the vehicle. The thermal management system includes a first portion in thermal communication with a component of the battery system, a heat exchanger portion in thermal communication with the fluid distribution system, and a first valve transitionable between a first configuration and a second configuration. The first portion is in fluid communication with the heat exchanger portion when the first valve is in the first configuration. The first valve blocks fluid communication between the first portion and the heat exchanger portion when the first valve is in the second configuration.

Still another embodiment relates to a method of operating a thermal management system. The method includes receiving, from one or more sensors, sensor data corresponding to a temperature of fluid in a fluid distribution system of a vehicle and to a temperature of coolant in the thermal management system, comparing, based on the sensor data, the temperature of the fluid to the temperature of the coolant, and operating, based on the comparison, the thermal management system between a first configuration and a second configuration. In the first configuration the coolant is in thermal communication with the fluid. In the second configuration the thermal management system blocks thermal communication between the coolant and the fluid.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a driveline of the vehicle of FIG. 1, according to an exemplary embodiment.

FIG. 4 is a block diagram of a battery system of the vehicle of FIG. 1, according to an exemplary embodiment.

FIG. 5 is a block diagram of a fluid distribution system of the vehicle of FIG. 1, according to an exemplary embodiment.

FIG. 6 is a block diagram of a portion of the vehicle of FIG. 1, according to an exemplary embodiment.

FIG. 7 is a block diagram of a thermal management system of the vehicle of FIG. 1, according to an exemplary embodiment.

FIG. 8 is a flow chart of a process for operating a thermal management system of a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a thermal management system of the present disclosure facilitates transferring heat between an electrical system of a vehicle and a fluid distribution system of a vehicle. The thermal management system is thermally coupled to the electrical system and includes a coolant, a radiator, a first valve configured to direct the coolant to the radiator or through a radiator bypass that bypasses the radiator, a heat exchanger thermally coupled to the fluid distribution system, and a second valve configured to direct the coolant to the heat exchanger or through a heat exchanger bypass that bypasses the heat exchanger. During a startup of the vehicle and/or during charging of a battery of the electrical system of the vehicle, the electrical system of the vehicle may produce heat and provide the heat to the coolant. When a fluid temperature of the fluid in the fluid distribution system is less than a coolant temperature of the coolant, the second valve is operated to direct the coolant to the heat exchanger such that heat can be transferred from the coolant to the fluid to increase the fluid temperature of the fluid towards the temperature of the coolant. When the fluid temperature of the fluid in the fluid distribution system is greater than or equal to the coolant temperature of the coolant, the second valve is operated to direct the coolant to the heat exchanger bypass such that heat is not transferred from the coolant to the fluid. When a coolant temperature of the coolant is less than a coolant temperature threshold, the first valve is operated to direct the coolant to the radiator bypass such that the radiator does not radiate heat from the coolant. When the coolant temperature of the coolant is greater than the coolant temperature threshold, the first valve is operated to direct the coolant to the radiator such that the radiator radiates heat from the coolant to an ambient atmosphere surrounding the vehicle.

### Overall Vehicle

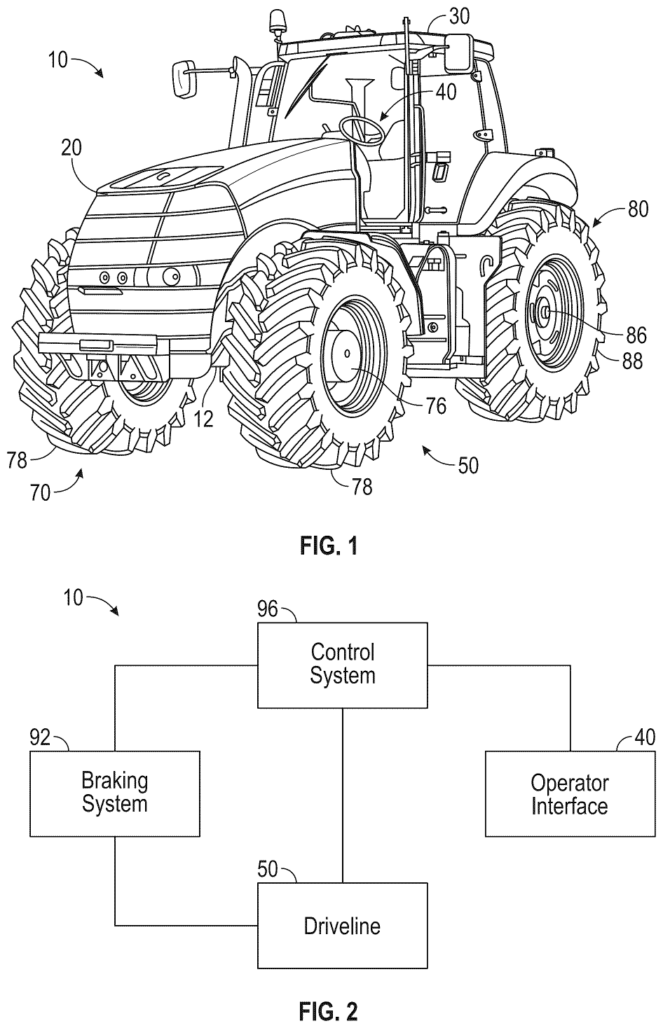

According to the exemplary embodiment shown in FIG. 1-3, a machine or vehicle (e.g., a non-articulated vehicle, an articulated vehicle, etc.), shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 92, coupled to one or more components of the driveline 50 to facilitate selectively braking the one or more components of the driveline 50; and a vehicle control system, shown as control system 96, coupled to the operator interface 40, the driveline 50, and the braking system 92. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 56) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, an LCD display, a LED display, a speedometer, gauges, warning lights, etc. The one or more input device may be or include a steering wheel, a joystick, buttons, switches, knobs, levers, an accelerator pedal, a brake pedal, etc.

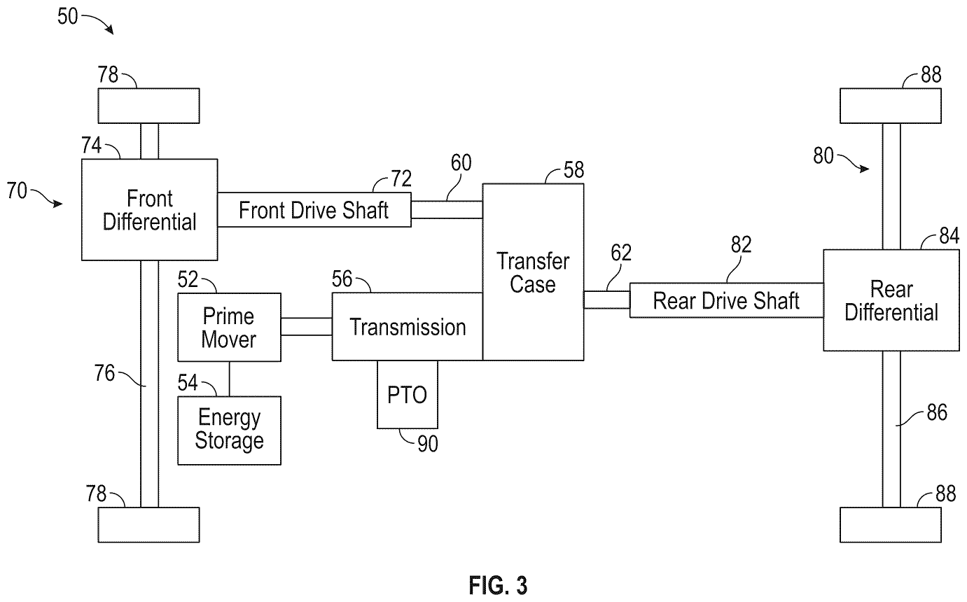

According to an exemplary embodiment, the driveline 50 is configured to propel the vehicle 10. As shown in FIG. 3, the driveline 50 is an electric driveline that includes a primary driver (e.g., prime mover, etc.), shown as electric motor 52, and an energy storage system (e.g., energy storage, etc.), shown as high voltage system 54. For example, the electric motor 52 may be electrically coupled to (e.g., in electrical communication with, etc.) the high voltage system 54 and may consume electrical energy from the high voltage system 54 in order to propel the vehicle 10. In some embodiments, the driveline 50 is a fuel cell electric driveline that includes the electric motor 52 and the energy storage system is a fuel cell (e.g., that stores hydrogen, that produces electricity from the hydrogen, etc.). In some embodiments, the driveline 50 is a hybrid driveline that includes (i) the electric motor 52 and an internal combustion engine and (ii) the high voltage system 54 and a fuel tank. In other embodiments, the driveline 50 is a conventional driveline where the primary driver is an internal combustion engine and the energy storage system is a fuel tank. The internal combustion engine may be a spark-ignition internal combustion engine or a compression-ignition internal combustion engine that may use any suitable fuel type (e.g., diesel, ethanol, gasoline, natural gas, propane, etc.).

As shown in FIG. 3, the driveline 50 includes a transmission device (e.g., a gearbox, a continuous variable transmission (“CVT”), etc.), shown as transmission 56, coupled to the electric motor 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the electric motor 52. In some embodiments (e.g., in electric driveline configurations, in hybrid driveline configurations, etc.), the driveline 50 does not include the transmission 56. In such embodiments, the electric motor 52 may be directly coupled to the transfer case 58. According to an exemplary embodiment, the transfer case 58 is configured to facilitate driving both the front tractive assembly 70 and the rear tractive assembly 80 with the electric motor 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the electric motor 52 (e.g., to permit free movement of the front tractive assembly 70 and the rear tractive assembly 80 in a neutral mode of operation). In some embodiments, the driveline 50 does not include the transfer case 58. In such embodiments, the electric motor 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the electric motor 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the electric motor 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of the electric motors 52. By way of example, the driveline 50 may include a first of the electric motors 52 that drives the front tractive assembly 70 and a second of the electric motors 52 that drives the rear tractive assembly 80. By way of another example, the driveline 50 may include a first of the electric motors 52 that drives a first one of the front tractive elements 78, a second of the electric motors 52 that drives a second one of the front tractive elements 78, a third of the electric motors 52 that drives a first one of the rear tractive elements 88, and/or a fourth of the electric motors 52 that drives a second one of the rear tractive elements 88. By way of still another example, the driveline 50 may include a first of the electric motors 52 that drives the front tractive assembly 70, a second of the electric motors 52 that drives a first one of the rear tractive elements 88, and a third of the electric motors 52 that drives a second one of the rear tractive elements 88. By way of yet another example, the driveline 50 may include a first of the electric motors 52 that drives the rear tractive assembly 80, a second of the electric motors 52 that drives a first one of the front tractive elements 78, and a third of the electric motors 52 that drives a second one of the front tractive elements 78. In such embodiments, the driveline 50 may not include the transmission 56 and/or the transfer case 58 or may include multiple of the transmissions 56 and/or the transfer cases 58 (e.g., one of the transmissions 56 and/or one of the transfer cases 58 for each of the electric motors 52, etc.).

As shown in FIG. 3, the driveline 50 includes a power-take-off (“PTO”), shown as PTO 90. While the PTO 90 is shown as being an output of the transmission 56, in other embodiments the PTO 90 may be an output of the electric motor 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 92 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 92 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

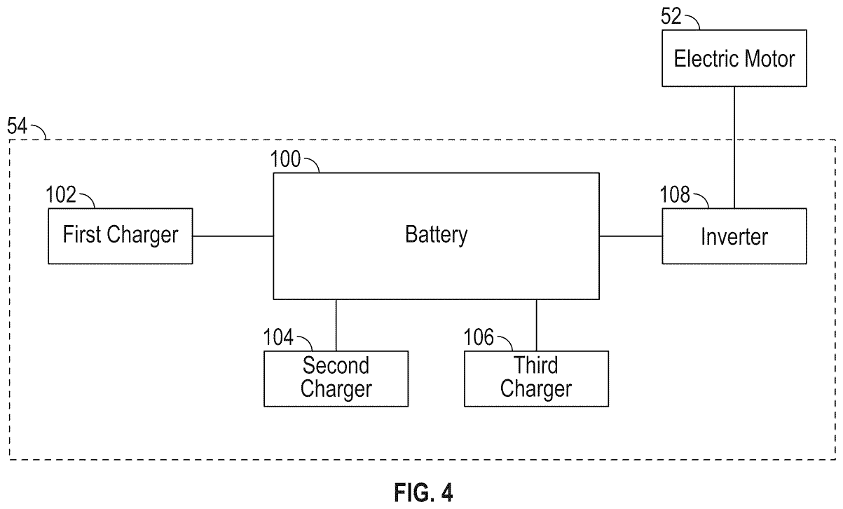

As shown in FIG. 4, the high voltage system 54 (e.g., battery system, etc.) includes a battery (e.g., a battery pack, a plurality of batteries, a battery assembly, etc.), shown as battery 100, configured to provide electrical energy to the electric motor 52 and/or systems of the vehicle 10, according to some embodiments. The battery 100 is configured to store electrical energy and provide the electrical energy to the electric motor 52 to operate the vehicle 10. For example, the battery 100 may be electrically coupled to the electric motor 52 through wiring to provide the electrical energy to the electric motor 52. In various embodiments, the battery 100 is electrically coupled to other electrical components of the vehicle 10 (e.g., the control system 96, the operator interface 40, etc.) and is configured to provide the electrical energy to the other electrical components of the vehicle 10. For example, the battery 100 may be electrically coupled to a display device of the operator interface and the battery 100 may provide the electrical energy to the display device to power the display device to display information associated with the vehicle 10 to the operator of the vehicle 10. In some embodiments, the high voltage system 54 may include a plurality of the batteries 100 (e.g., a plurality of battery cells, etc.).

As shown in FIG. 4, the high voltage system 54 includes a first charger assembly (e.g., a first charging device, a first charger assembly, etc.), shown as first charger 102, configured to receive electrical energy from and/or provide electrical energy to a first external source (e.g., external to the vehicle 10, external to the high voltage system 54, etc.), according to some embodiments. The first charger 102 is electrically coupled to the battery 100. For example, the first charger 102 may be configured to receive electrical energy from an external charging station. In some embodiments, the first charger 102 is configured to provide the electrical energy received from the external source to the battery 100. For example, when charging the battery 100, the first charger 102 may receive electrical energy from the first external source and provide the electrical energy to the battery 100. The first charger 102 may generate heat while receiving the electrical energy and/or providing the electrical energy.

As shown in FIG. 4, the high voltage system 54 includes a second charger assembly (e.g., a second charging device, a second charger assembly, etc.), shown as second charger 104, configured to receive electrical energy from and/or provide electrical energy to a second external source (e.g., external to the vehicle 10, external to the high voltage system 54, etc.), according to some embodiments. The second charger 104 is electrically coupled to the battery 100. For example, the second charger 104 may be configured to provide electrical energy to an attachment assembly (e.g., a mower attachment, a harvesting attachment, etc.) configured to couple to the vehicle 10 such that the high voltage system 54 may provide the electrical energy to the attachment assembly to power the attachment assembly. In some embodiments, the second charger 104 is configured to provide the electrical energy received from the battery 100 to the second external source. The second charger 104 may generate heat while receiving the electrical energy and/or providing the electrical energy. In other embodiments, the high voltage system 54 does not include the second charger 104.

As shown in FIG. 4, the high voltage system 54 includes a third charger assembly (e.g., a third charging device, a third charger assembly, etc.), shown as third charger 106, configured to receive electrical energy from and/or provide electrical energy to a third external source (e.g., external to the vehicle 10, external to the high voltage system 54, etc.), according to some embodiments. The third charger 106 is electrically coupled to the battery 100. For example, the third charger 106 may be configured to provide electrical energy to the operator interface 40 such that the high voltage system 54 may provide the electrical energy to the operator interface 40 to power the operator interface 40. In some embodiments, the third charger 106 is configured to provide the electrical energy received from the battery 100 to the third external source. The third charger 106 may generate heat while receiving the electrical energy and/or providing the electrical energy. In other embodiments, the high voltage system 54 does not include the third charger 106.

As shown in FIG. 4, the high voltage system 54 includes an inverter (e.g., a power distribution unit, a drive unit, a motor controller, etc.), shown as inverter 108, electrically coupled between the battery 100 and the electric motor 52, according to some embodiments. In some embodiments, the inverter 108 is configured to receive the electrical energy from the battery 100 and convert the electrical energy before providing the electrical energy to the electric motor 52. For example, the inverter 108 may receive the electrical energy from the battery with direct current (“DC”) and the inverter 108 may convert the electrical energy to have alternating current (“AC”) before providing the electrical energy to the electric motor 52 (e.g., when the electric motor 52 is configured to be powered by a different type of electrical energy than stored in the battery 100, etc.). The inverter 108 may generate heat while converting the electrical energy received from the battery 100.

### Fluid Distribution System

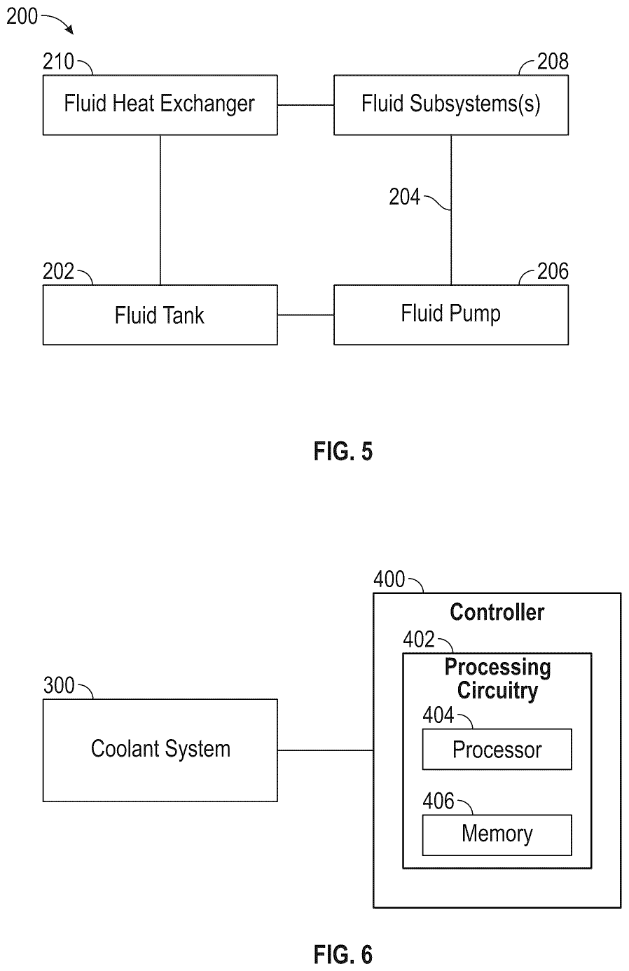

As shown in FIG. 5, the vehicle 10 includes a fluid system (e.g., a transmission oil system, gearbox oil system, hydraulic system, etc.), shown as fluid distribution system 200. The fluid distribution system 200 includes: a reservoir, shown as fluid reservoir 202, configured to store a fluid (e.g., oil, water glycol solution, hydraulic fluid, hydraulic oil, etc.); a series of lines (e.g., pipes, tubes, etc.), shown as fluid distribution lines 204, fluidly coupled to the fluid reservoir 202 and configured to convey the fluid through the fluid distribution system 200; a pump, shown as fluid distribution pump 206, fluidly coupled to the fluid reservoir 202 by the fluid distribution lines 204 and configured to pump (e.g., circulate, etc.) the fluid through the fluid distribution system 200 (e.g., produce a flow of the fluid, etc.); and at least one fluid receiving subsystem (e.g., a hydraulic outlet, hydraulic subsystem, lubrication subsystem, etc.), shown as fluid subsystem 208, fluidly coupled with the fluid reservoir 202 and the fluid distribution pump 206 by the fluid reservoir 202. In some embodiments, the fluid distribution system 200 includes a plurality of the fluid subsystems 208 (e.g., a first fluid subsystem, a second fluid subsystem, a third fluid subsystem, etc.). In some embodiments, the vehicle 10 includes a plurality of the fluid distribution systems 200 (e.g., a first fluid system, a second fluid system, etc.). Each of the fluid distribution systems 200 may include the same fluid or different types of fluid (e.g., hydraulic oil, lubrication oil, fertilizing fluid, etc.).

According to the embodiment shown in FIG. 5, the fluid subsystem 208 is positioned downstream of the fluid distribution pump 206 such that the fluid flows through the fluid distribution pump 206 when flowing from the fluid reservoir 202 to the fluid subsystem 208. In other embodiments, the fluid subsystem 208 is positioned upstream of the fluid distribution pump 206 such that the fluid flows through the fluid subsystem 208 when flowing from the fluid reservoir 202 to the fluid distribution pump 206. In still other embodiments, the fluid distribution system 200 does not include the fluid distribution pump 206 (e.g., when the fluid distribution system 200 is a passive system, etc.).

According to an exemplary embodiment, at least one of the fluid subsystems 208 is a hydraulic subsystem that is configured to receive hydraulic fluid from the fluid distribution pump 206 and utilize the flow of the hydraulic fluid to perform a function. For example, the fluid subsystem 208 may be a hydraulic steering subsystem configured to steer (e.g., turn, direct, etc.) the front tractive element or the rear tractive element 88, a transmission hydraulic subsystem configured to alternate the configuration of the transmission 56, and/or an auxiliary hydraulic subsystem configured to operate an auxiliary subsystem (e.g., a lift system, a manipulator system, etc.) of the vehicle 10. As another example, the fluid subsystem 208 may be an external hydraulic subsystem that is associated with the vehicle 10. For example, the fluid subsystem 208 may be a sprayer that is configured to be towed by the vehicle 10. In some embodiments, the fluid distribution system 200 includes a plurality of the fluid subsystems 208 that are hydraulic subsystems (e.g., a first hydraulic subsystem, a second hydraulic subsystem, a third hydraulic subsystem, etc.).

According to an exemplary embodiment, at least one of the fluid subsystems 208 is a lubrication subsystem that is configured to receive lubrication fluid (e.g., lubrication oil, lubricating oil, etc.) from the fluid distribution pump 206 and provide the lubrication fluid to a component of the vehicle 10 to lubricate the component of the vehicle 10. For example, the lubrication subsystem may provide the lubrication oil to the driveline 50 to lubricate moving components of the driveline 50 (e.g., the transmission 56, the transfer case 58, the electric motor 52, etc.), to the front tractive assembly 70 to lubricate moving components of the front tractive assembly 70 (e.g., the front drive shaft 72, the front differential 74, the front axle 76, the front tractive elements 78, etc.), to the rear tractive assembly 80 to lubricate moving components of the rear tractive assembly 80 (e.g., the rear drive shaft 82, the rear differential 84, the rear axle 86, the rear tractive elements 88, etc.), and/or to other components of the vehicle 10 to lubricate other moving components of the vehicle 10. In some embodiments, when the fluid subsystem 208 is associated with the transmission 56, the fluid reservoir 202 may be included in the transmission 56. For example, the transmission 56 may include a cavity configured as the fluid reservoir 202 configured to store the fluid that flows through the fluid subsystem 208.

According to an exemplary embodiment, the fluid distribution pump 206 is coupled to the PTO 90 such that the fluid distribution pump 206 is driven by the PTO 90. The PTO 90 may drive the fluid distribution pump 206 at operating speeds relative to the operating speed of the electric motor 52. In other embodiments, the fluid distribution pump 206 is driven by another electric motor (e.g., a second electric motor, etc.) electrically coupled to the battery 100 and controlled by the control system 96.

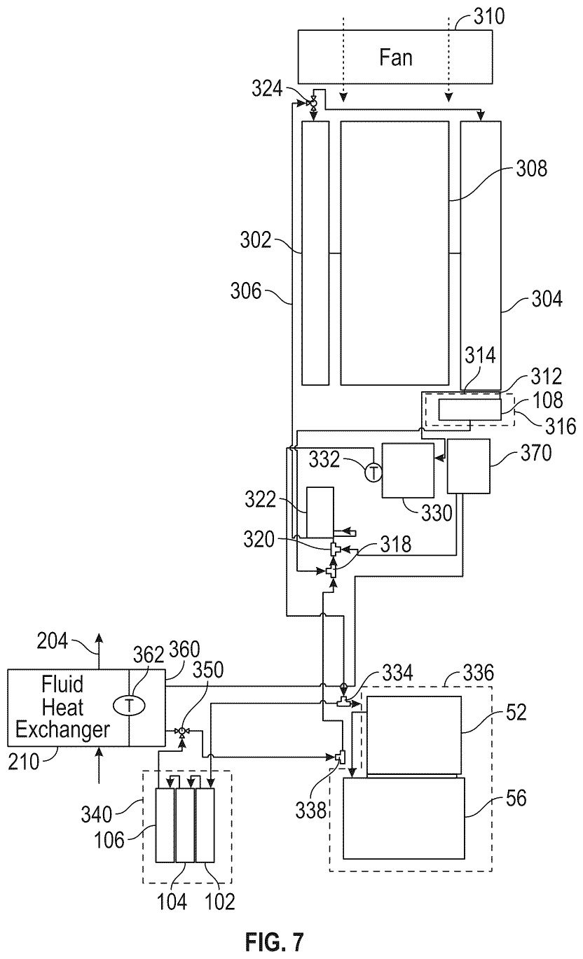

According to the exemplary embodiment shown in FIGS. 5 and 7, the fluid distribution system 200 includes a first heat exchanger portion (e.g., a first core of a dual core heat exchanger, etc.), shown as fluid heat exchanger portion 210, configured to thermally couple to another heat exchanger portion (e.g., a second heat exchanger portion, etc.) to transfer heat between the fluid heat exchanger portion 210 and the other heat exchanger portion. For example, the fluid heat exchanger portion 210 may receive heat from the other heat exchanger portion and provide the heat to the fluid in the fluid distribution system 200 to increase a temperature of the fluid in the fluid distribution system 200. In some embodiments, when the vehicle 10 includes the plurality of the fluid distribution systems 200, each of the fluid heat exchanger portions 210 of the fluid distribution systems 200 are configured to couple to another heat exchanger portion to transfer heat between the each of the fluid heat exchanger portions 210 and the other heat exchanger portion.

### Thermal Management System

As shown in FIG. 6, the vehicle 10 includes a thermal management system, shown as thermal management system 300, configured to manage temperature of the vehicle 10, according to some embodiments. The thermal management system 300 is thermally coupled to (e.g., in thermal communication with, etc.) the fluid distribution system 200 (e.g., via the fluid heat exchanger portion 210, etc.) and is configured to receive heat from and/or transfer heat to the fluid distribution system 200. For example, the thermal management system 300 may be configured to provide heat to the fluid heat exchanger portion 210 such that the fluid heat exchanger portion 210 increases the temperature of the fluid in the fluid distribution system 200. The thermal management system 300 is thermally coupled to the high voltage system 54, the electric motor 52, and/or the transmission 56 and is configured to receive heat from and/or transfer heat to the high voltage system 54, the electric motor 52, and/or the transmission 56. For example, during operation of the vehicle 10, the high voltage system 54. The electric motor 52, and/or the transmission may generate heat. The thermal management system 300 may receive the heat from the high voltage system 54, the electric motor 52, and/or the transmission 56 to decrease a temperature of the high voltage system 54, the electric motor 52, and/or the transmission 56. As a result, the thermal management system 300 may utilize the heat generated by the high voltage system 54, the electric motor 52, and/or the transmission 56 to increase a temperature of the fluid in the fluid distribution system 200.

According to an exemplary embodiment, the thermal management system 300 is configured to transfer heat generated by the high voltage system 54, the electric motor 52, and/or the transmission 56 to the fluid of the fluid distribution system 200. For example, during a start-up sequence of the vehicle 10 (e.g., an ignition, a start of operation of the vehicle 10, etc.), a temperature of the fluid in the fluid distribution system 200 may be similar to an ambient temperature of the surroundings of the vehicle 10 (e.g., due to heat transferring between the fluid and the surroundings while the vehicle 10 is not being operated, etc.). As a result of the temperature of the fluid in the fluid distribution system 200, characteristics (e.g., viscosities, etc.) of the fluid may be in a non-optimal range for operation of the fluid distribution system 200. Advantageously, the thermal management system 300 may transfer heat generated by the high voltage system 54, the electric motor 52, and/or the transmission 56 during the start-up sequence of the vehicle 10 (e.g., due to a high current draw of the electric motor 52, while transferring current through the first charger 102, the second charger 104 and/or the third charger 106, etc.) to the fluid of the fluid distribution system 200 increase the temperature of the fluid into an optimal range (e.g., an operating range, etc.) for operation of the fluid distribution system 200 such that performance characteristics of the fluid distribution system 200 are improved. For example, the reaction time of the fluid distribution system 200 may be increased, the power consumption of the fluid distribution system 200 may be decreased, etc. Once the temperature of the fluid in the fluid distribution system 200 is within the optimal range, the thermal management system 300 may maintain the temperature of the fluid within the optimal range.

As shown in FIG. 7, the thermal management system 300 includes a coolant (e.g., coolant fluid, antifreeze, radiator fluid, engine coolant, etc.), a first reservoir (e.g., a first storage tank, a first fluid container, a first tank, a radiator conduit, etc.), shown as radiator reservoir 302, configured to store the coolant, a second reservoir (e.g., a second storage tank, a second fluid container, a second tank, a bypass conduit, etc.), shown as bypass reservoir 304, configured to store the coolant, and a series of conduits (e.g., lines, pipes, hoses, etc.), shown as coolant lines 306, fluidly coupled to (e.g., in fluid communication with, coupled to allow fluid communication with, etc.) the radiator reservoir 302 and the bypass reservoir 304 and configured to convey the coolant from the radiator reservoir 302 and the bypass reservoir 304 through the thermal management system 300, according to some embodiments. The coolant may be a fluid that has a sufficiently high thermal conductivity such that the coolant may absorb heat from the high voltage system 54, the electric motor 52, and/or the transmission 56. The coolant lines 306 may carry (e.g., facilitate the transfer or flow of, etc.) the coolant around the thermal management system 300.

As shown in FIG. 7, the thermal management system 300 includes a radiator (e.g., a heat exchanger, a heat emitter, etc.), shown as radiator 308, fluidly coupled between the radiator reservoir 302 and the bypass reservoir 304 and configured to receive heat from the coolant, according to some embodiments. For example, the radiator 308 may be configured to receive coolant from the radiator reservoir 302, receive heat contained in the coolant passing through the radiator 308 and radiate the heat to air surrounding the radiator 308 to decrease the temperature of the coolant passing through the radiator 308, and provide the coolant to the bypass reservoir 304. In some embodiments, the radiator 308 may be oriented towards an opening in the body 20 of the vehicle 10 such that movement of the vehicle 10 forces air across the radiator 308 to increase an amount of heat radiated from the radiator 308 compared to when air is not forced across the radiator 308.

As shown in FIG. 7, the thermal management system 300 includes a fan (e.g., a blower, etc.), shown as radiator fan 310, configured to force air over the radiator 308, according to some embodiments. By forcing air across the radiator 308, a rate of heat transfer between the radiator 308 and the air surrounding the radiator 308 may be increased compared to when air is not forced across the radiator 308, allowing for the radiator 308 to remove additional heat from the coolant flowing through the radiator 308 and further decrease the temperature of the coolant flowing through the radiator 308. In some embodiments, the radiator fan 310 may be a variable-speed fan configured to be operated at different speeds to force different volumes and/or flow rates of air over the radiator 308. For example, the radiator fan 310 may be operated at a first speed to force a first flow rate of air across the radiator 308 that results in a first heat transfer rate between the coolant in the radiator 308 and the air and a second speed faster than the first speed to force a second flow rate of air across the radiator 308 greater than the first flow rate of air that results in a second heat transfer rate between the coolant in the radiator 308 and the air that is greater than the first heat transfer rate. In some embodiments, the radiator fan 310 produces a first portion of forced air forced across the radiator 308 and the movement of the vehicle 10 produces a second portion of forced air forced across the radiator 308. In other embodiments, the thermal management system 300 does not include the radiator fan 310 (e.g., when the movement of the vehicle 10 forces air across the radiator 308, etc.).

As shown in FIG. 7, the bypass reservoir 304 includes a first outlet, shown as first radiator outlet 312, configured to provide the coolant from the bypass reservoir 304, and a second outlet, shown as second radiator outlet 314, configured to provide the coolant from the bypass reservoir 304. For example, a first portion of the coolant provided by the bypass reservoir 304 may be provided through the first radiator outlet 312 and a second portion of the coolant provided by the bypass reservoir 304 may be provided through the second radiator outlet 314.

As shown in FIG. 7, a first portion of the thermal management system 300 fluidly coupled to the first radiator outlet 312, shown as first portion 316, is thermally coupled (e.g., configured to receive heat from, configured to provide heat to, etc.) to the inverter 108, according to some embodiments. For example, the coolant provided by the bypass reservoir 304 through the first radiator outlet 312 may receive the heat generated by the inverter 108. In some embodiments, the first portion 316 of the thermal management system 300 is fluidly coupled to the inverter 108 to thermally couple the thermal management system 300 to the inverter 108. For example, the inverter 108 may include an inverter conduit fluidly coupled to the first radiator outlet 312 and configured to receive the coolant from the first radiator outlet 312. The inverter 108 may transfer the heat to the coolant when the coolant is flowing through the inverter conduit. In other embodiments, the first portion 316 of the thermal management system 300 thermally coupled to the inverter 108 is a heat exchanger configured to receive heat from the inverter 108 and transfer the heat to the coolant flowing through the heat exchanger of the first portion of the thermal management system 300.

As shown in FIG. 7, the thermal management system 300 includes a first junction (e.g., T-junction, three-way junction, etc.), shown as first junction conduit 318, fluidly coupled to the second radiator outlet 314. In some embodiments, the first junction conduit 318 is positioned downstream of the first portion 316 of the thermal management system 300 thermally coupled to the inverter 108. For example, a first inlet of the first junction conduit 318 may be fluidly coupled to the first radiator outlet 312 and configured to receive the coolant output by the radiator 308 through the first radiator outlet 312 after the coolant has received the heat from the inverter 108. In other embodiments, the first junction conduit 318 is otherwise positioned relative to other components of the thermal management system 300 and/or the flow of the coolant through the thermal management system 300.

As shown in FIG. 7, the thermal management system 300 includes a second junction, shown as second junction conduit 320, fluidly coupled to the first junction conduit 318. In some embodiments, the second junction conduit 320 is positioned downstream of the first junction conduit 318. For example, a first inlet of the second junction conduit 320 may be fluidly coupled to an outlet of the first junction conduit 318 and configured to receive the coolant output by the first junction conduit 318 through the outlet of the first junction conduit 318. In other embodiments, the second junction conduit 320 is otherwise positioned relative to the first junction conduit 318 (e.g., upstream of the first portion 316, etc.).

As shown in FIG. 7, the thermal management system 300 includes a pump (e.g., a compressor, etc.), shown as pump 322, fluidly coupled to the second junction conduit 320, according to some embodiments. In some embodiments, the pump 322 is a variable speed pump that is configured to pump coolant through the thermal management system 300 at different flow rates. For example, the pump 322 may be operated at a first speed to pump the coolant through the thermal management system 300 at a first flow rate and at a second speed higher than the first speed to pump the coolant through the thermal management system 300 at a second flow rate that is greater than the first flow rate. In some embodiments, the pump 322 is positioned downstream of the second junction conduit 320. For example, an inlet of the pump 322 may be fluidly coupled to an outlet of the second junction conduit 320 and configured to receive the coolant output by the second junction conduit 320 through the outlet of the second junction conduit 320. In other embodiments, the pump 322 is otherwise positioned in the thermal management system 300 (e.g., positioned downstream of the radiator reservoir 302 and/or the bypass reservoir 304, etc.).

As shown in FIG. 7, the thermal management system 300 includes a first valve, shown as radiator bypass valve 324, fluidly coupled to the pump 322, fluidly coupled to the radiator reservoir 302, and fluidly coupled to the bypass reservoir 304, according to some embodiments. The radiator bypass valve 324 is positioned downstream of the pump 322. For example, an inlet of the radiator bypass valve 324 may be fluidly coupled to an outlet of the pump 322 and be configured to receive the coolant output (e.g., pumped, pressurized, etc.) by the pump 322 through an outlet of the pump 322.

The radiator bypass valve 324 is positioned upstream of the radiator reservoir 302 and the bypass reservoir 304. In some embodiments, the radiator bypass valve 324 is configured to selectively provide the coolant to the radiator reservoir 302 or the bypass reservoir 304 such that the coolant flowing through the radiator bypass valve 324 flows (i) into the radiator reservoir 302, through the radiator 308, and into the bypass reservoir 304 or (ii) into the bypass reservoir 304 without passing through the radiator 308 (e.g., bypassing the radiator reservoir 302, bypassing the radiator 308, directly into the bypass reservoir 304, etc.). For example, the radiator bypass valve 324 may be a two-way vale configured to direct the coolant received by the radiator bypass valve 324 to an inlet of the radiator reservoir 302 or to an inlet of the bypass reservoir 304. As another example, the radiator bypass valve 324 may be transitionable between a first configuration where the radiator bypass valve 324 allows fluid communication between the first portion 316 and the radiator 308 and a second configuration where the radiator bypass valve 324 blocks fluid communication between the first portion 316 and the radiator 308. By causing the coolant to bypass the radiator 308, the radiator bypass valve 324 may be operated to control the temperature of the coolant in the thermal management system 300 by selectively allowing for heat to be removed from the coolant by the radiator 308 when the coolant is directed by the radiator bypass valve 324 through the radiator 308 or selectively preventing heat from being removed from the coolant by the radiator 308 when the coolant is directed by the radiator bypass valve 324 directly to the bypass reservoir 304. In other embodiments, the thermal management system 300 does not include the radiator reservoir 302 and the radiator bypass valve 324 selectively provides the coolant to the radiator 308 or the bypass reservoir 304.

In some embodiments, the radiator bypass valve 324 is configured to selectively provide a first portion of the coolant flowing through the radiator bypass valve 324 to the radiator reservoir 302 and a second portion of the coolant flowing through the radiator bypass valve 324 to the bypass reservoir 304. For example, the radiator bypass valve 324 may have a first configuration where the radiator bypass valve 324 directs all of the coolant flowing through the radiator bypass valve 324 to the radiator reservoir 302, a second configuration where the radiator bypass valve 324 directs all of the coolant flowing through the radiator bypass valve 324 to the bypass reservoir 304, and an intermediate configuration (e.g., a third configuration, etc.) where the radiator bypass valve 324 directs the first portion of the coolant to the radiator reservoir 302 and the second portion of the coolant to the bypass reservoir 304. As a result, the radiator bypass valve 324 may be operated to control the temperature of the coolant flowing through the thermal management system 300 with a greater accuracy than when the radiator bypass valve 324 only includes the first configuration and the second configuration.

As shown in FIG. 7, the thermal management system 300 includes a condenser (e.g., a condensing unit, etc.), shown as liquid condenser 330, fluidly coupled to the second radiator outlet 314 of the bypass reservoir 304, according to some embodiments. The liquid condenser 330 is configured to decrease a temperature of the coolant received by the liquid condenser 330. For example, the liquid condenser 330 may receive the coolant from the bypass reservoir 304 through the second radiator outlet 314 that is at a first temperature. The liquid condenser 330 may decrease the temperature of the coolant from the first temperature to a second temperature that is lower than the first temperature. In some embodiments, the liquid condenser 330 may transform the coolant flowing through the liquid condenser 330 from a vapor into a liquid to decrease the temperature of the coolant flowing through the liquid condenser 330. In some embodiments, the radiator fan 310 is configured to force air across the liquid condenser 330 to further remove heat from the coolant flowing through the thermal management system 300. In other embodiments, the thermal management system 300 includes a second fan configured to force air across the liquid condenser 330. In some embodiments, the liquid condenser 330 is positioned downstream of the second radiator outlet 314. In other embodiments, the liquid condenser 330 is otherwise positioned in the thermal management system 300 (e.g., positioned upstream of the radiator bypass valve 324, etc.).

As shown in FIG. 7, the thermal management system 300 includes a first temperature sensor, shown as condenser temperature sensor 332, configured to obtain temperature data associated with the temperature of the coolant output by the liquid condenser 330. For example, the condenser temperature sensor 332 may be positioned proximate an outlet of the liquid condenser 330 and be configured to obtain the temperature data associated with the coolant flowing through the outlet of the liquid condenser 330. In some embodiments, the thermal management system 300 includes additional temperature sensors (e.g., a second temperature sensor, etc.) configured to obtain temperature data associated with the temperature of the coolant received by the liquid condenser 330. For example, the thermal management system 300 may include a temperature sensor positioned proximate an inlet of the liquid condenser 330 that is configured to obtain the temperature data associated with the coolant flowing through the inlet of the liquid condenser 330.

As shown in FIG. 7, the thermal management system 300 includes a third junction, shown as third junction conduit 334, fluidly coupled to the liquid condenser 330. In some embodiments, the third junction conduit 334 is positioned downstream of the liquid condenser 330. For example, a first inlet of the third junction conduit 334 may be fluidly coupled to the liquid condenser 330 and configured to receive the coolant output by the liquid condenser 330 (e.g., through the outlet of the liquid condenser 330, etc.). In other embodiments, the third junction conduit 334 is otherwise positioned relative to other components of the thermal management system 300 and/or the flow of the coolant through the thermal management system 300.

As shown in FIG. 7, a second portion of the thermal management system 300 fluidly coupled to a first outlet of the third junction conduit 334, shown as second portion 336, is thermally coupled to the electric motor 52 and/or the transmission 56, according to some embodiments. For example, the coolant output by the third junction conduit 334 through the first outlet of the third junction conduit 334 may receive the heat generated by the electric motor 52 and/or the transmission 56. In some embodiments, the second portion 336 of the thermal management system 300 is positioned downstream of the third junction conduit 334. In other embodiments, the second portion 336 of the thermal management system 300 is otherwise positioned relative to the third junction conduit 334 (e.g., upstream of the third junction conduit 334, etc.).

According to the exemplary embodiment shown in FIG. 7, the second portion 336 of the thermal management system 300 is thermally coupled to the electric motor 52 and the transmission 56 in series. For example, the coolant flowing through the thermal management system 300 may be output through the outlet of the third junction conduit 334, flow past the electric motor 52 and receive heat from the electric motor 52, and then flow past the transmission 56 and receive heat from the transmission 56. In other embodiments, the second portion 336 of the thermal management system 300 is thermally coupled to the electric motor 52 and the transmission 56 in parallel. For example, the coolant flowing through the thermal management system 300 may be output through the outlet of the third junction conduit 334, a first portion of the coolant output by the first outlet of the third junction conduit 334 may flow past the electric motor 52 and receive heat from the electric motor 52, and a second portion of the coolant output by the second outlet of the third junction conduit 334 may flow past the transmission 56 and receive heat from the transmission 56.

In some embodiments, the second portion 336 of the thermal management system 300 is fluidly coupled to the electric motor 52 and/or the transmission 56 to thermally couple the thermal management system 300 to the electric motor 52 and/or the transmission 56. For example, the electric motor 52 and/or the transmission 56 may include conduits fluidly coupled to the third junction conduit 334 and configured to receive the coolant output by the third junction conduit 334. The electric motor 52 and/or the transmission 56 may transfer the heat to the coolant when the coolant is flowing through the conduits defined by the electric motor 52 and/or the transmission 56. In other embodiments, the second portion 336 of the thermal management system 300 thermally coupled to the electric motor 52 and/or the transmission 56 is a heat exchanger configured to receive heat from the electric motor 52 and/or the transmission 56 and transfer the heat to the coolant flowing through the heat exchanger of the second portion 336 of the thermal management system 300.

As shown in FIG. 7, the thermal management system 300 includes a fourth junction, shown as fourth junction conduit 338, fluidly coupled to the third junction conduit 334. In some embodiments, the fourth junction conduit 338 is positioned downstream of the second portion 336 of the thermal management system 300 thermally coupled to the electric motor 52 and/or the transmission 56. For example, a first inlet of the fourth junction conduit 338 may be fluidly coupled to the first outlet of the third junction conduit 334 and configured to receive the coolant output by the third junction conduit 334 and the coolant has received the heat from the electric motor 52 and/or the transmission 56. In other embodiments, the third junction conduit 334 is otherwise positioned relative to other components of the thermal management system 300 and/or the flow of the coolant through the thermal management system 300.

As shown in FIG. 7, the fourth junction conduit 338 is fluidly coupled to the first junction conduit 318. In some embodiments, the first junction conduit 318 is positioned downstream of the fourth junction conduit 338. For example, a second inlet of the first junction conduit 318 may be fluidly coupled with an outlet of the fourth junction conduit 338 and configured to receive the coolant output by the fourth junction conduit 338. In other embodiments, the first junction conduit 318 is otherwise positioned relative to the fourth junction conduit 338 (e.g., upstream of the fourth junction conduit 338, etc.).

As shown in FIG. 7, a third portion of the thermal management system 300 fluidly coupled to a second outlet of the third junction conduit 334, shown as third portion 340, is thermally coupled to the first charger 102, the second charger 104, and/or the third charger 106, according to some embodiments. For example, the coolant output by the third junction conduit 334 through the second outlet of the third junction conduit 334 may receive the heat generated by the first charger 102, the second charger 104, and/or the third charger 106. In some embodiments, the second portion 336 and the third portion 340 of the thermal management system 300 operate in parallel. For example, when the coolant flows through the thermal management system 300, a first portion of the coolant may be directed by the third junction conduit 334 through the second portion 336 and a second portion of the coolant may be directed by the third junction conduit 334 through the third portion 340. In other embodiments, the second portion 336 and the third portion 340 of the thermal management system 300 are operated in series. In some embodiments, the third portion 340 of the thermal management system 300 is positioned downstream of the third junction conduit 334. In other embodiments, the third portion 340 of the thermal management system 300 is otherwise positioned relative to the third junction conduit 334 (e.g., upstream of the third junction conduit 334, etc.).

According to the exemplary embodiment shown in FIG. 7, the third portion 340 of the thermal management system 300 is thermally coupled to the first charger 102, the second charger 104, and the third charger 106 in series. For example, the coolant flowing through the thermal management system 300 may be output through the second outlet of the third junction conduit 334, flow past the first charger 102 and receive heat from the first charger 102, flow past the second charger 104 and receive heat from the second charger 104, and then flow past the third charger 106 and receive heat from the third charger 106. In other embodiments, the third portion 340 of the thermal management system 300 is thermally coupled to the first charger 102, the second charger 104, and the third charger 106 in parallel. For example, the coolant flowing through the thermal management system 300 may be output through the second outlet of the third junction conduit 334, a first portion of the coolant output by the second outlet of the third junction conduit 334 may flow past the first charger 102 and receive heat from the first charger 102, a second portion of the coolant output by the second outlet of the third junction conduit 334 may flow past the second charger 104 and receive heat from the second charger 104 and a third portion of the coolant output by the second outlet of the third junction conduit 334 may flow past the third charger 106 and receive heat from the third charger 106.

In some embodiments, the third portion 340 of the thermal management system 300 is fluidly coupled to the first charger 102, the second charger 104, and/or the third charger 106 to thermally coupled the thermal management system 300 to the first charger 102, the second charger 104, and/or the third charger 106. For example, the first charger 102, the second charger 104, and/or the second charger 104 may define conduits fluidly coupled to the third junction conduit 334 and configured to receive the coolant output by the third junction conduit 334. The first charger 102, the second charger 104, and/or the third charger 106 may transfer the heat to the coolant when the coolant is flowing through the conduits defined by the first charger 102, the second charger 104, and/or the third charger 106. In other embodiments, the third portion 340 of the thermal management system 300 thermally coupled to the first charger 102, the second charger 104, and/or the third charger 106 is a heat exchanger configured to receive heat from the first charger 102, the second charger 104, and/or the third charger 106 and transfer the heat to the coolant flowing through the heat exchanger of the third portion 340 of the thermal management system 300.

As shown in FIG. 7, the thermal management system 300 includes a second valve, shown as heat exchanger bypass valve 350, fluidly coupled to the third junction conduit 334 and fluidly coupled to the fourth junction conduit 338; and a second heat exchanger portion (e.g., a second portion of a dual core heat exchanger, etc.), shown as coolant heat exchanger portion 360, fluidly coupled to the heat exchanger bypass valve 350 and thermally coupled to the fluid heat exchanger portion 210, according to some embodiments. The heat exchanger bypass valve 350 is positioned downstream of the third junction conduit 334. For example, an inlet of the heat exchanger bypass valve 350 may be fluidly coupled to a second outlet of the third junction conduit 334 and be configured to receive the coolant output by the second outlet of the third junction conduit 334. In some embodiments, the coolant heat exchanger portion 360 is thermally coupled to each of the fluid heat exchanger portions 210 of the multiple of the fluid distribution systems 200 (e.g., when the vehicle 10 includes the multiple of the fluid distribution systems 200, etc.). In other embodiments, the thermal management system includes a plurality of the coolant heat exchanger portions 360 that are each thermally coupled to at least one of the fluid heat exchanger portions 210 of the multiple of the fluid distribution systems 200 (e.g., when the vehicle 10 includes the multiple of the fluid distribution systems 200, etc.).

The coolant heat exchanger portion 360 of the thermal management system 300 and the fluid heat exchanger portion 210 of the fluid distribution system 200 are configured to transfer heat between the fluid of the fluid distribution system 200 and the coolant of the thermal management system 300. For example, when a coolant temperature of the coolant in the coolant heat exchanger portion 360 is higher than a fluid temperature of the fluid in the fluid heat exchanger portion 210, the fluid heat exchanger portion 210 and the coolant heat exchanger portion 360 may transfer heat from the coolant to the fluid to increase the fluid temperature of the fluid and decrease the coolant temperature of the coolant.

The heat exchanger bypass valve 350 is positioned upstream of the fourth junction conduit 338 and the coolant heat exchanger portion 360. For example, a first outlet of the heat exchanger bypass valve 350 may be fluidly coupled to a second inlet of the fourth junction conduit 338 and a second outlet of the heat exchanger bypass valve 350 may be fluidly coupled to an inlet of the coolant heat exchanger portion 360. In some embodiments, the heat exchanger bypass valve 350 is configured to selectively provide the coolant to the fourth junction conduit 338 or the coolant heat exchanger portion 360 such that the coolant flowing through the heat exchanger bypass valve 350 flows into the coolant heat exchanger portion 360 or into the fourth junction conduit 338 without passing through the coolant heat exchanger portion 360 (e.g., bypassing the coolant heat exchanger portion 360, directly to the pump 322, etc.). For example, the heat exchanger bypass valve 350 may be a two-way valve configured to direct the coolant received by the heat exchanger bypass valve 350 to the inlet of the coolant heat exchanger portion 360 or to the second inlet of the fourth junction conduit 338. As another example, the heat exchanger bypass valve 350 may be transitionable between a first configuration that allows fluid communication between the first portion 316, the second portion 336, and/or the third portion 340 and the coolant heat exchanger portion 360 and a second configuration that blocks fluid communication between the first portion 316, the second portion 336, and/or the third portion 340 and the coolant heat exchanger portion 360. By causing the coolant to bypass the coolant heat exchanger portion 360, the heat exchanger bypass valve 350 may be operated to control the temperature of the fluid in the fluid distribution system 200 by selectively allowing for heat to be transferred from the coolant to the fluid via the coolant heat exchanger portion 360 and the fluid heat exchanger portion 210 when the coolant is directed by the heat exchanger bypass valve 350 to the coolant heat exchanger portion 360 or selectively preventing heat from being transferred from the coolant to the fluid via the coolant heat exchanger portion 360 and the fluid heat exchanger portion 210 when the coolant is directed by the heat exchanger bypass valve 350 to the fourth junction conduit 338. In various embodiments, the second outlet of the heat exchanger bypass valve 350 is fluidly coupled to other components of the thermal management system 300 (e.g., fluidly coupled to the first junction conduit 318, fluidly coupled to the second junction conduit 320, fluidly coupled to the pump 322, etc.).

In some embodiments, the heat exchanger bypass valve 350 is configured to selectively provide a first portion of the coolant flowing through the heat exchanger bypass valve 350 to the coolant heat exchanger portion 360 and a second portion of the coolant flowing through the heat exchanger bypass valve 350 to the fourth junction conduit 338. For example, the heat exchanger bypass valve 350 may have a first configuration where the heat exchanger bypass valve 350 directs all of the coolant flowing through the heat exchanger bypass valve 350 to the coolant heat exchanger portion 360, a second configuration where the heat exchanger bypass valve 350 directs all of the coolant flowing through the heat exchanger bypass valve 350 to the fourth junction conduit 338, and an intermediate configuration (e.g., a third configuration, etc.) where the heat exchanger bypass valve 350 directs the first portion of the coolant to the coolant heat exchanger portion 360 and the second portion of the coolant to the fourth junction conduit 338. As a result, the heat exchanger bypass valve 350 may be operated to control the temperature of the fluid flowing through the fluid distribution system 200 with a greater accuracy than when the heat exchanger bypass valve 350 only includes the first configuration and the second configuration.

As shown in FIG. 7, the thermal management system 300 includes a second temperature sensor, shown as heat exchanger temperature sensor 362, configured to obtain temperature data associated with the temperature of the coolant in the coolant heat exchanger portion 360 and/or the temperature of the fluid in the fluid heat exchanger portion 210. For example, the heat exchanger temperature sensor 362 may be positioned proximate an outlet of the coolant heat exchanger portion 360 and configured to obtain the temperature data associated with the coolant flowing through the outlet of the coolant heat exchanger portion 360. As another example, the heat exchanger temperature sensor 362 may be positioned proximate an outlet of the fluid heat exchanger portion 210 and configured to obtain the temperature data associated with the fluid flowing through the outlet of the fluid heat exchanger portion 210. In various embodiments, the thermal management system 300 includes a first of the heat exchanger temperature sensors 362 configured to obtain temperature data associated with the temperature of the coolant in the coolant heat exchanger portion 360 and a second of the heat exchanger temperature sensors 362 configured to obtain temperature data associated with the temperature of the fluid in the fluid heat exchanger portion 210.

As shown in FIG. 7, the thermal management system 300 includes a gas removal assembly, shown as degas bottle 370, fluidly coupled to the coolant heat exchanger portion 360, fluidly coupled to the second junction conduit 320, and configured to remove gas in the coolant flowing through the degas bottle 370. In some embodiments, the degas bottle 370 is positioned downstream of the coolant heat exchanger portion 360 and upstream of the second junction conduit 320. For example, an inlet of the degas bottle 370 may be fluidly coupled to an outlet of the coolant heat exchanger portion 360 and an outlet of the degas bottle 370 may be fluidly coupled to a second inlet of the second junction conduit 320. In other embodiments, the degas bottle 370 is otherwise positioned relative to the coolant heat exchanger portion 360 and/or the second junction conduit 320 (e.g., upstream to the coolant heat exchanger portion 360, downstream to the second junction conduit 320, etc.).

### Control System

As shown in FIG. 6, the vehicle 10 includes a control system, shown as controller 400, configured to operate the thermal management system 300, according to some embodiments. The controller 400 may be included in the control system 96 or may be separate from the control system 96. The controller 400 includes processing circuitry 402 including a processor 404 and memory 406. The processing circuitry 402 may be communicably connected with a communications interface of controller 400 such that processing circuitry 402 and the various components thereof can send and receive data via the communications interface. The processor 404 may be implemented as a general purpose processor, an application specific integrated circuit (ASIC), one or more field programmable gate arrays (FPGAs), a group of processing components, or other suitable electronic processing components.

The memory 406 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. The memory 406 may be or include volatile memory or non-volatile memory. The memory 406 may include database components, object code components, script components, or any other type of information structure for supporting the various activities and information structures described in the present application. According to some embodiments, the memory 406 is communicably connected to the processor 404 via the processing circuitry 402 and includes computer code for executing (e.g., by at least one of the processing circuitry 402 or the processor 404) one or more processes described herein.

The controller 400 is configured to receive inputs (e.g., pressure data, temperature data, sensor data, operating characteristics, etc.) from the thermal management system 300 and/or the fluid distribution system 200, according to some embodiments. For example, the controller 400 may receive temperature data from the condenser temperature sensor 332 corresponding to the temperature of the coolant output by the liquid condenser 330, temperature data from the heat exchanger temperature sensor 362 corresponding to the temperature of the coolant output by the coolant heat exchanger portion 360, and/or temperature data from a temperature sensor corresponding to the temperature of the fluid output by the fluid heat exchanger portion 210. The controller 400 may be configured to provide control outputs (e.g., control decisions, control signals, etc.) to the elements of the thermal management system 300 based on the inputs received by the controller 400. For example, the controller 400 may generate a control signal for the radiator bypass valve 324 to direct the coolant flowing through the radiator bypass valve 324 into the radiator reservoir 302 in response to receiving temperature data from the condenser temperature sensor 332 indicating that the temperature of the coolant output by the liquid condenser 330 is above (e.g., exceeds, etc.) a temperature threshold. The controller 400 may operate automatically based on programing or may use some combination of automatic control and manual operation.

In some embodiments, the controller 400 is configured to receive inputs (e.g., selections, settings, etc.) from the operator interface 40 of the vehicle 10, according to some embodiments. For example, the controller 400 may receive a user input via the operator interface 40 from the operator of the vehicle 10 associated with starting operation of the vehicle 10 (e.g., an ignition user input, a turn of a key, a pressing of an ignition button, etc.). The controller 400 may provide control outputs to the thermal management system 300 based on the user input. For example, if the user input is associated with starting operation of the vehicle 10, the controller 400 may send a control signal to the heat exchanger bypass valve 350 to provide the coolant to the coolant heat exchanger portion 360 so that the coolant provides heat to the fluid in the fluid heat exchanger portion 210 and increase a temperature of the fluid.

In response to the inputs, the controller 400 may provide control signals to the radiator bypass valve 324 to operate the radiator bypass valve 324 selectively direct the coolant flowing through the radiator bypass valve 324 to the radiator reservoir 302 and/or the bypass reservoir 304. For example, in response to receiving temperature data indicating that the coolant in the thermal management system 300 is above a first coolant temperature threshold, the controller 400 may provide a control signal to the radiator bypass valve 324 to operate the radiator bypass valve 324 to increase an amount of the coolant flowing through the radiator bypass valve 324 that is directed into the radiator reservoir 302 (e.g., decrease an amount of the coolant flowing through the radiator bypass valve 324 that is directed to the bypass reservoir 304, etc.) and, thus, into the radiator 308. As a result, the radiator 308 may radiate a portion of the heat contained in the coolant and the temperature of the coolant may be decreased toward the first coolant temperature threshold. As another example, in response to receive temperature data indicating that the coolant in the thermal management system 300 is below the first coolant temperature threshold, the controller 400 may provide a control signal to the radiator bypass valve 324 to operate the radiator bypass valve 324 to increase an amount of the coolant flowing through the radiator bypass valve 324 that is directed into the bypass reservoir 304 (e.g., an amount that bypasses the radiator 308, etc.). As a result, heat from the heat producing components of the vehicle 10 (e.g., the inverter 108, the electric motor 52, etc.) may increase a temperature of the coolant in the thermal management system 300 toward the first coolant temperature threshold. In various embodiments, the controller 400 provides control signals to the radiator bypass valve 324 to operate the radiator bypass valve 324 based on temperature data corresponding to the temperature of the fluid in the fluid distribution system 200.

In response to the inputs, the controller 400 may provide control signals to the radiator fan 310 to operate the radiator fan 310. For example, in response to receiving temperature data indicating that the coolant in the thermal management system 300 is above a second coolant temperature threshold, the controller 400 may provide a control signal to the radiator fan 310 to operate the radiator fan 310 to force air across the radiator 308 to increase an amount of heat that is removed from the coolant flowing through the radiator 308 compared to when the radiator fan 310 does not force air across the radiator 308. As a result, the radiator 308 may radiate a portion of the heat contained in the coolant into the air forced across the radiator 308 by the radiator fan 310 and the temperature of the coolant may be decreased toward the second coolant temperature threshold. As another example, in response to receiving temperature data indicating that the coolant in the thermal management system 300 is below the second coolant temperature threshold, the controller 400 may provide a control signal to the radiator fan 310 to stop operation of the radiator fan 310 to stop forcing air across the radiator 308. As a result, the radiator may radiate less heat contained into the coolant into the air than when the radiator fan 310 is forcing air across the radiator 308 and the temperature of the coolant may increase toward the second coolant temperature threshold. In some embodiments, the second coolant temperature threshold is greater than the first coolant temperature threshold. In other embodiments, the second coolant temperature thresholds is less than or equal to the first coolant temperature threshold. In various embodiments, the controller 400 provides control signals to the radiator fan 310 to operate the radiator fan 310 based on temperature data corresponding to the temperature of the fluid in the fluid distribution system 200.

In response to the inputs, the controller 400 may provide control signals to the pump 322 to operate the pump 322. For example, in response to receiving temperature data indicating that the coolant in the thermal management system 300 is above a third coolant temperature threshold, the controller 400 may provide a control signal to the pump 322 to increase a flow rate of the coolant through the thermal management system 300 such that a rate of heat transfer between the coolant and the air surrounding the radiator 308 is increased. As a result, the radiator 308 may radiate a greater amount of heat from the coolant such that the temperature of the coolant decreases toward the third coolant temperature threshold. As another example, in response to receiving temperature data indicating that the coolant in the thermal management system 300 is below the third coolant temperature threshold, the controller 400 may provide a control signal to the pump 322 to decrease the flow rate of the coolant through the thermal management system 300 such that the rate of heat transfer between the coolant and the air surrounding the radiator 308 is decreased. As a result, the radiator 308 may radiate a lesser amount of heat from the coolant such that the temperature of the coolant increases toward the third coolant threshold. In some embodiments, the third temperature threshold is greater than the first temperature threshold and/or the second temperature threshold. In other embodiments, the third temperature threshold is less than or equal to the first temperature threshold and/or the second temperature threshold. In various embodiments, the controller 400 provides control signals to the pump 322 to operate the pump 322 based on temperature data corresponding to the temperature of the fluid in the fluid distribution system 200.

In response to the inputs, the controller 400 may provide control signals to the heat exchanger bypass valve 350 to operate the heat exchanger bypass valve 350. For example, in response to receiving temperature data indicating that the fluid in the fluid distribution system 200 is below a fluid temperature threshold (e.g., a hydraulic temperature threshold, a maximum temperature threshold, etc.), the controller 400 may provide a control signal to the heat exchanger bypass valve 350 to increase an amount of the coolant flowing through the heat exchanger bypass valve 350 that is directed into the coolant heat exchanger portion 360 (e.g., decrease an amount of the coolant flowing through the heat exchanger bypass valve 350 that is directed to the fourth junction conduit 338, etc.). As a result, the coolant heat exchanger portion 360 may provide additional heat from the coolant flowing through the coolant heat exchanger portion 360 to the fluid flowing through the fluid heat exchanger portion 210 and the temperature of the fluid may be increased toward the temperature threshold. As another example, in response to receiving temperature data indicating that the fluid in the fluid distribution system 200 is below the fluid temperature threshold, the controller 400 may provide a control signal to the heat exchanger bypass valve 350 to increase an amount of the coolant flowing through the heat exchanger bypass valve 350 that is directed to the fourth junction conduit 338 (e.g., decrease an amount of the coolant flowing through the heat exchanger bypass valve 350 that is directed into the coolant heat exchanger portion 360, etc.). As a result, the coolant heat exchanger portion 360 may provide less heat from the coolant in the thermal management system 300 to the fluid flowing through the fluid heat exchanger portion 210 and the temperature of the fluid may be decreased toward the fluid temperature threshold.

The fluid temperature threshold may be a minimum temperature of the fluid in the fluid distribution system 200 that results in optimal performance of the fluid distribution system 200. For example, when the fluid distribution system 200 is a hydraulic system and when the temperature of the hydraulic fluid in the fluid distribution system 200 is below the hydraulic temperature threshold, the hydraulic system may react slowly (e.g., sluggishly, etc.) to control inputs received from the operator interface 40. For example, when the temperature of the hydraulic fluid is below the hydraulic threshold, a viscosity of the hydraulic fluid may be higher than when the temperature of the hydraulic fluid is above the hydraulic threshold, increasing a difficulty of moving the hydraulic fluid through the fluid distribution system 200. Therefore, by utilizing the heat generated by the thermal management system 300 to heat the fluid in the fluid distribution system 200 when the temperature of the fluid is below the fluid temperature threshold, the performance of the fluid distribution system 200 of the vehicle 10 may be increased while utilizing the heat generated by the thermal management system 300 that would otherwise be waste.

In some embodiments, the controller 400 compares the temperature of the fluid in the fluid distribution system 200 to the temperature of the coolant in the thermal management system 300 and control signals to the heat exchanger bypass valve 350 to operate the heat exchanger bypass valve 350 in response to the comparison between the temperature of the fluid and the temperature of the coolant. For example, in response to the temperature of the fluid being less than the temperature of the coolant, the controller 400 may provide a control signal to the heat exchanger bypass valve 350 to increase an amount of the coolant flowing through the heat exchanger bypass valve 350 that is directed into the coolant heat exchanger portion 360 (e.g., operate the heat exchanger bypass valve 350 toward the first configuration of the heat exchanger bypass valve 350, operate the heat exchanger bypass valve 350 to place the heat exchanger bypass valve 350 in the first configuration, etc.). As another example, in response to the temperature of the fluid in the fluid distribution system 200 being greater than or equal to the temperature of the coolant, the controller 400 may provide a control signal to the heat exchanger bypass valve 350 to decrease an amount of the coolant flowing through the heat exchanger bypass valve 350 that is directed into the coolant heat exchanger portion 360 (e.g., operate the heat exchanger bypass valve 350 toward the second configuration of the heat exchanger bypass valve 350, operate the heat exchanger bypass valve 350 to place the heat exchanger bypass valve 350 in the second configuration, etc.). In some embodiments, the controller 400 obtains the temperature of the fluid from the heat exchanger temperature sensor 362 and the temperature of the coolant from the condenser temperature sensor 332.

### Process for Operating a Thermal Management System

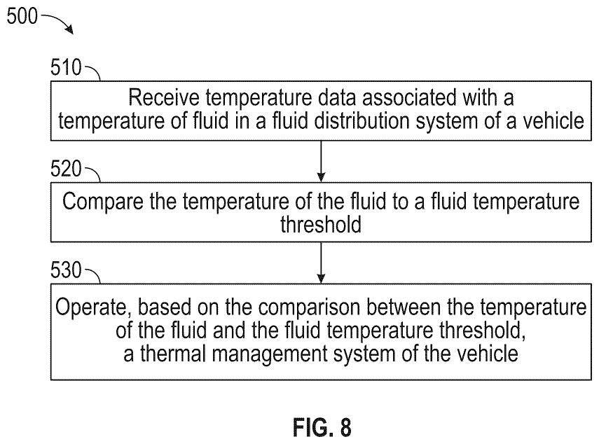

Referring to FIG. 8, a process 500 (e.g., a method, etc.) for operating a thermal management system of a vehicle includes steps 510-530, according to some embodiments. The process 500 may be performed, at least in part, by the controller 400. In some embodiments, the process 500 is performed for the thermal management system 300 of the vehicle 10 such that the heat exchanger bypass valve 350 can be operated between different configurations of the heat exchanger bypass valve 350 to direct different amounts of the coolant flowing through the heat exchanger bypass valve 350 to the coolant heat exchanger portion 360 to transfer different amounts of heat between the coolant and the fluid in the fluid distribution system 200.

The process 500 includes receiving temperature data associated with a temperature of a fluid in a fluid distribution system of a vehicle (step 510), according to some embodiments. In some embodiments, the vehicle is the vehicle 10 and includes the fluid distribution system 200. The temperature data may be associated with a temperature of the fluid of the fluid distribution system 200. For example, the temperature data may be generated by the heat exchanger temperature sensor 362 and may correspond to the temperature of the fluid output by the fluid heat exchanger portion 210 of the fluid distribution system 200.

The process 500 includes comparing the temperature of the fluid to a fluid temperature threshold (step 520), according to some embodiments. The fluid temperature threshold may correspond to a minimum operating temperature of the fluid in the fluid distribution system 200 that results in optimal operation of the fluid distribution system 200. For example, when the fluid distribution system 200 is a hydraulic system, the fluid temperature threshold may be a predetermined hydraulic temperature threshold based on hydraulic testing of the fluid distribution system 200. In some embodiments, the fluid temperature threshold is a temperature of the coolant in the thermal management system. For example, the temperature of the fluid in the fluid distribution system 200 may exceed the fluid temperature threshold when the temperature of the fluid exceeds the temperature of the coolant.

The process 500 includes operating a thermal management system of a vehicle (step 530), according to some embodiments. In some embodiments, the thermal management system is operated based on the comparison between the temperature of the fluid and the fluid temperature threshold performed during step 520. For example, when the temperature of the fluid is below the fluid temperature threshold, the thermal management system 300 may be operated into a first configuration (e.g., placed in the first configuration, etc.) where the coolant in the thermal management system 300 is in thermal communication with the fluid in the fluid distribution system 200. The coolant in the thermal management system 300 may be placed in thermal communication with the fluid in the fluid distribution system 200 by operating the heat exchanger bypass valve 350 to direct the coolant flowing through the heat exchanger bypass valve 350 to the coolant heat exchanger portion 360 to increase an amount of heat transferred from the coolant flowing through the coolant heat exchanger portion 360 to the fluid flowing through the fluid heat exchanger portion 210 in order to increase a temperature of the fluid. As another example, when the temperature of the fluid is above the fluid temperature threshold, the thermal management system 300 may be operated into a second configuration (e.g., placed in the second configuration, etc.) where the thermal management system 300 blocks thermal communication between the coolant in the thermal management system 300 and the fluid in the fluid distribution system 200. The thermal management system 300 may block thermal communication between the coolant and the fluid by operating the heat exchanger bypass valve 350 to direct the coolant flowing through the heat exchanger bypass valve 350 away from the coolant heat exchanger portion 360 (e.g., toward the fourth junction conduit 338, etc.) to decrease an amount of heat transferred from the coolant flowing through the coolant heat exchanger portion 360 to the fluid flowing through the fluid heat exchanger portion 210 in order to decrease a temperature of the fluid.

In some embodiments, the controller 400 operates the thermal management system 300 based on the comparison between the temperature of the fluid and the fluid temperature threshold performed during step 520. The controller 400 may operate the thermal management system 300 to reduce a difference between the temperature of the fluid in the fluid distribution system 200 and the fluid temperature threshold. For example, if the temperature of the fluid is less than the fluid temperature threshold, the controller 400 may operate the heat exchanger bypass valve 350 to increase an amount of the coolant directed to the coolant heat exchanger portion 360 such that an amount of heat transferred from the coolant to the fluid is increased. As another example, if the temperature of the fluid is greater than the fluid temperature threshold, the controller 400 may operate the heat exchanger bypass valve 350 to decrease an amount of the coolant directed to the coolant heat exchanger portion 360 such that an amount of heat transferred from the coolant to the fluid is decreased.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

It is important to note that the construction and arrangement of the vehicle 10 and the systems and components thereof (e.g., the driveline 50, the braking system 92, the control system 96, etc.) as shown in the various exemplary embodiments is illustrative only. Additionally, any element disclosed in one embodiment may be incorporated or utilized with any other embodiment disclosed herein.

What is claimed is:

1. A thermal management system for a vehicle, comprising;
a pump configured to circulate a coolant through the thermal management system;
a first portion in fluid communication with the pump, the first portion in thermal communication with a component of a drivetrain of the vehicle;
a heat exchanger portion in thermal communication with a fluid distribution system for the vehicle; and
a first valve transitionable between a first configuration and a second configuration;
wherein the first portion is in fluid communication with the heat exchanger portion when the first valve is in the first configuration; and
wherein the first valve blocks fluid communication between the first portion and the heat exchanger portion when the first valve is in the second configuration.

2. The thermal management system of claim 1, wherein the thermal management system further comprises:
one or more sensors configured to generate sensor data corresponding to a temperature of fluid in the fluid distribution system and a temperature of the coolant in the thermal management system; and
a controller operatively coupled to the one or more sensors, the controller configured to:
receive the sensor data;
compare, based on the sensor data, the temperature of the fluid to the temperature of the coolant; and
operate, based on the comparison, the first valve between the first configuration and the second configuration.

3. The thermal management system of claim 2, wherein:
the controller is configured to, responsive to the temperature of the fluid being less than the temperature of the coolant, operate the first valve towards the first configuration.

4. The thermal management system of claim 3, wherein:
the controller is configured to, responsive to the temperature of the fluid being greater than or equal to the temperature of the coolant, operate the first valve towards the second configuration.

5. The thermal management system of claim 1, wherein the thermal management system further comprises:
a radiator configured to radiate heat from the coolant; and
a second valve transitionable between a first configuration and a second configuration;
wherein the first portion is in fluid communication with the radiator when the second valve is in the first configuration; and
wherein the second valve blocks fluid communication between the first portion and the radiator when the second valve is in the second configuration.

6. The thermal management system of claim 5, wherein the pump is fluidly coupled between the first valve and the second valve.

7. The thermal management system of claim 5, wherein the thermal management system further comprises:
one or more sensors configured to generate sensor data corresponding to a temperature of fluid in the fluid distribution system and a temperature of coolant in the thermal management system; and
a controller operatively coupled to the one or more sensors, the controller configured to:
receive the sensor data;
compare, based on the sensor data, the temperature of the fluid to the temperature of the coolant;
operate, based on the comparison, the first valve between the first configuration and the second configuration; and
operate, based on a comparison between the temperature of the coolant and a coolant temperature threshold, the second valve between the first configuration and the second configuration.

8. The thermal management system of claim 7, wherein:
the controller is configured to, responsive to the temperature of the fluid being less than the temperature of the coolant, operate the first valve towards the first configuration; and
the controller is configured to, responsive to the temperature of the coolant being greater than the coolant temperature threshold, operate the second valve towards the first configuration.

9. The thermal management system of claim 1, wherein:
the component of the drivetrain is an electric motor;
the thermal management system further comprises a second portion in fluid communication with the first portion and in thermal communication with an inverter of the drivetrain of the vehicle, the inverter configured to provide electrical energy to the electric motor; and
the coolant flows through the first portion and the second portion in series.

10. The thermal management system of claim 1, wherein:
the component of the drivetrain is an inverter configured to provide electrical energy to an electric motor of the vehicle;
the thermal management system further comprises a second portion in fluid communication with the first portion and in thermal communication with a charger of the drivetrain of the vehicle, the charger in electrical communication with the inverter; and
the coolant flows through the first portion and the second portion in series.

11. The thermal management system of claim 1, wherein:
the component of the drivetrain is an electric motor;
the thermal management system further comprises a second portion in fluid communication with the first portion and in thermal communication with a charger of the drivetrain of the vehicle, the charger in electrical communication with the electric motor; and
a first portion of the coolant flows through the first portion in parallel to a second portion of the coolant flowing through the second portion.

12. A vehicle comprising:
a chassis;
a drivetrain coupled to the chassis, the drivetrain comprising:
a battery system, and
an electric motor configured to consume electrical energy provided by the battery system to propel the vehicle;
a fluid distribution system configured to circulate fluid to at least one subsystem of the vehicle; and
a thermal management system configured to circulate coolant, the thermal management system comprising:
a first portion in thermal communication with a component of the battery system,
a heat exchanger portion in thermal communication with the fluid distribution system, and
a first valve transitionable between a first configuration and a second configuration;
wherein the first portion is in fluid communication with the heat exchanger portion when the first valve is in the first configuration; and
wherein the first valve blocks fluid communication between the first portion and the heat exchanger portion when the first valve is in the second configuration.

13. The vehicle of claim 12, wherein the thermal management system further comprises:
one or more sensors configured to generate sensor data corresponding to a temperature of fluid in the fluid distribution system and a temperature of the coolant in the thermal management system; and
a controller operatively coupled to the one or more sensors, the controller configured to:
receive the sensor data;
compare, based on the sensor data, the temperature of the fluid to the temperature of the coolant; and
operate, based on the comparison, the first valve between the first configuration and the second configuration.

14. The vehicle of claim 13, wherein the controller is configured to:
responsive to the temperature of the fluid being less than the temperature of the coolant, operate the first valve towards the first configuration; and
responsive to the temperature of the fluid being greater than or equal to the temperature of the coolant, operate the first valve between the first configuration and the second configuration to maintain the temperature of the fluid within an operating range such that the temperature of fluid does not exceed a maximum temperature threshold.

15. The vehicle of claim 12, wherein the thermal management system further comprises:
a radiator configured to radiate heat from the coolant;
a radiator fan configured to provide air to the radiator; and
a second valve transitionable between a first configuration and a second configuration;
wherein the first portion is in fluid communication with the radiator when the second valve is in the first configuration; and
wherein the second valve blocks fluid communication between the first portion and the radiator when the second valve is in the second configuration.

16. The vehicle of claim 15, wherein the thermal management system further comprises:
one or more sensors configured to generate sensor data corresponding to a temperature of the coolant in the thermal management system; and
a controller operatively coupled to the one or more sensors, the controller configured to:
receive the sensor data;
operate, responsive to the temperature of the coolant exceeding a first coolant temperature threshold, the second valve towards the first configuration; and
operate, responsive to the temperature of the coolant exceeding a second coolant temperature threshold, the radiator fan to provide the air to the radiator.

17. The vehicle of claim 16, wherein:
the sensor data corresponds to a temperature of the fluid in the fluid distribution system; and
the controller is further configured to:
operate, responsive to the temperature of the fluid being greater than or equal to the temperature of the coolant, the first valve toward the second configuration.

18. A method of operating a thermal management system, the method comprising:
receiving, from one or more sensors, sensor data corresponding to a temperature of fluid in a fluid distribution system of a vehicle and to a temperature of coolant in the thermal management system;
comparing, based on the sensor data, the temperature of the fluid to the temperature of the coolant; and
operating, based on the comparison, the thermal management system between a first configuration and a second configuration;
wherein in the first configuration the coolant is in thermal communication with the fluid; and
wherein in the second configuration the thermal management system blocks thermal communication between the coolant and the fluid.

19. The method of claim 18, wherein:
responsive to the temperature of the fluid being less than the temperature of the coolant, the thermal management system is operated in the first configuration; and
responsive to the temperature of the fluid being greater than or equal to the temperature of the coolant, the thermal management system is operated in the second configuration.

20. The method of claim 19, wherein the thermal management system is in thermal communication a component of an electric drivetrain of the vehicle.
